(19) United States
(12) Patent Application Publication
(10) Pub. No.: US 2026/0065846 A1
(43) Pub. Date: Mar. 5, 2026

(54) DATA DRIVER AND DISPLAY DEVICE INCLUDING THE SAME

(71) Applicant: LG Display Co., Ltd., Seoul (KR)

(72) Inventors: Sang Jin NAM, Paju-si (KR); Seung Jin YOO, Paju-si (KR); Hyun Gi HONG, Paju-si (KR)

(73) Assignee: LG Display Co., Ltd., Seoul (KR)

(21) Appl. No.: 19/227,223

(22) Filed: Jun. 3, 2025

(30) Foreign Application Priority Data
Sep. 5, 2024 (KR) 10-2024-0120783

(51) Int. Cl. G09G 3/32; G09G 3/3275

(52) U.S. Cl. CPC G09G 3/32; G09G 3/3275; G09G 2310/0275; G09G 2310/08; G09G 2320/0233; G09G 2320/0257; G09G 2330/021; G09G 2330/028

(57) ABSTRACT

A data driver according to an embodiment and a display device including the same are disclosed. The data driver includes an output circuit configured to alternately output a first image data voltage corresponding to first image data, and a second image data voltage corresponding to second image data obtained by inverting a phase of the first image data voltage with respect to a predetermined voltage, during one frame period; and a control circuit configured to supply the first image data and the second image data.

### CROSS-REFERENCE TO RELATED APPLICATION

This application claims priority to and the benefit of Korean Patent Application No. 10-2024-0120783, filed Sep. 5, 2024, the disclosure of which is incorporated herein by reference in its entirety.

### BACKGROUND

### Technical Field

The present disclosure relates to a data driver and a display device including the same.

### Description of Related Art

Various flat panel display devices such as a liquid crystal display device, an electroluminescent display device, and the like are known. The electroluminescent display device may display an input image by emitting light by itself without a backlight by using the light-emitting elements disposed on each of the pixels. The light-emitting elements of the electroluminescent display device may be divided into an organic light-emitting element and an inorganic light-emitting element according to the material of the light-emitting layer.

Recently, a display device that uses a light-emitting diode (LED), an inorganic light-emitting element, as a light-emitting element of a pixel has attracted attention as a next-generation display device. Since LEDs are made of inorganic materials, they do not require a separate encapsulation layer to protect organic materials from moisture, and they are more reliable and have a longer lifespan than organic light-emitting diodes (OLEDs). In addition, LEDs have a fast lighting speed, excellent luminous efficiency, and impact resistance.

### BRIEF SUMMARY

A plurality of LEDs arranged in an LED display device have a characteristic of high luminous efficiency under a high driving current, and thus, duty driving that drives the LEDs with a high current for a short period of time is used. In order to perform duty driving, a method of sequentially applying image data voltages during one frame period and then sequentially applying black data voltages is used.

In such a driving method, an afterimage restoration phenomenon in which a pattern displayed on the previous screen is observed as an afterimage occurs, and the afterimage restoration phenomenon is caused by a hysteresis phenomenon of a PMOS transistor in a pixel.

Accordingly, when a PMOS transistor is used as a driving element, luminance deviation occurs because the driving characteristics of the driving element cannot be stabilized due to a hysteresis phenomenon.

The present disclosure is directed to display techniques that reduce hysteresis of the PMOS transistor. The present disclosure provides a data driver and a display device including the same.

It should be noted that features of the present disclosure are not limited to the those specifically described herein, and other features of the present disclosure will be apparent to those skilled in the art from the descriptions herein.

A data driver according to embodiments of the present disclosure may include an output circuit configured to alternately output a first image data voltage corresponding to first image data, and a second image data voltage corresponding to second image data obtained by inverting a phase of the first image data voltage with respect to a predetermined voltage, during one frame period; and a control circuit configured to supply the first image data and the second image data.

A display device according to embodiments of the present disclosure may include a pixel array in which a plurality of data lines, a plurality of gate lines, and a plurality of pixel circuits are arranged; a data driver configured to output a first image data voltage and a second image data voltage to the plurality of data lines; a gate driver configured to output gate signals to the plurality of gate lines; and a timing controller configured to control the data driver and the gate driver, wherein the data driver includes: an output circuit configured to output a first image data voltage corresponding to first image data, and a second image data voltage corresponding to second image data obtained by inverting a phase of the first image data voltage with respect to a predetermined voltage during one frame period; and a control circuit configured to supply the first image data and the second image data.

The present disclosure may reduce hysteresis of a PMOS transistor by alternately outputting a first image data voltage, and a second image data voltage which is obtained by inverting the phase of the first image data voltage with respect to a predetermined voltage, during one frame period.

The present disclosure may improve an afterimage restoration phenomenon by reducing hysteresis of a PMOS transistor.

The present disclosure may enable low-power driving by reducing power consumption through duty driving.

The effects of the present specification are not limited to the above-mentioned effects, and other effects that are not mentioned will be apparently understood by those skilled in the art from the following description and the appended claims.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with respect to the attached drawings, in which:

FIG. 1 is a block diagram showing a display device according to an embodiment of the present disclosure;

FIG. 2 is a diagram showing a pixel circuit according to an embodiment of the present disclosure;

FIG. 3 is a diagram showing a configuration of a data driver according to an embodiment of the present disclosure;

FIG. 4 is a diagram showing a configuration of a gamma voltage generation circuit shown in FIG. 3;

FIGS. 5A to 5C are diagrams for explaining a data voltage application principle according to a first embodiment;

FIGS. 6A to 6C are diagrams for explaining a data voltage application principle according to a second embodiment;

FIGS. 7A to 7C are diagrams for explaining a data voltage application principle according to a third embodiment; and

FIGS. 8A to 8B are diagrams showing simulation results according to the embodiment.

### DETAILED DESCRIPTION

Advantages and features of the present specification and methods of achieving them will become apparent with reference to example embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

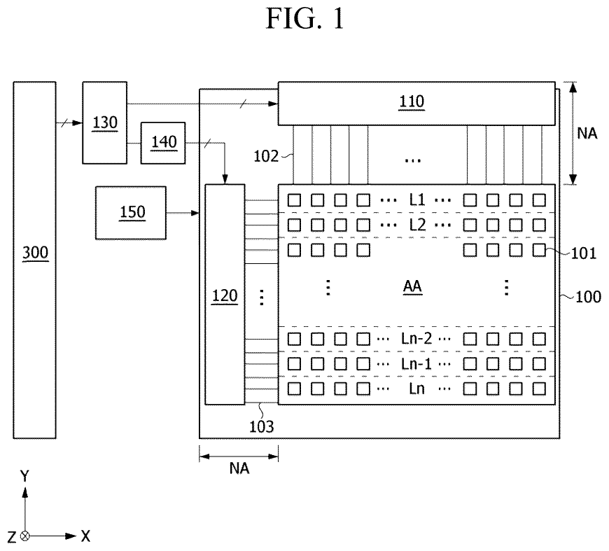

FIG. 1 is a block diagram showing a display device according to an embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The pixels may be arranged as real color pixels and pentile pixels. A pentile pixel may realize a higher resolution than a real color pixel by driving two sub-pixels with different colors as one pixel 101 and using a preset pixel rendering algorithm. This pixel rendering algorithm may compensate for insufficient color representation in each pixel with the color of light emitted from adjacent pixels.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 300 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The data driver 110 may alternately output a first image data voltage, and a second image data voltage which is obtained by inverting the phase of the first image data voltage with respect to a predetermined voltage during each frame period.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals using shift registers. When a plurality of gate signals are applied to each pixel, the gate driver 120 may include a plurality of shift registers. The gate signal may include a scan signal being input to the pixel circuit through a plurality of gate lines, and an emission signal (or EM signal).

The timing controller 130 receives digital video data of an input image and a timing signal synchronized with this data from the host system 300. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of I horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

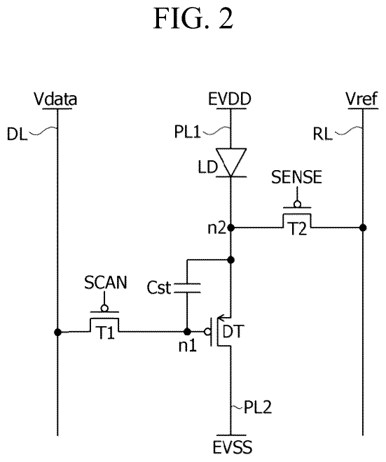

FIG. 2 is a diagram showing a pixel circuit according to an embodiment of the present disclosure.

Referring to FIG. 2, a pixel circuit according to an embodiment of the present disclosure includes a light-emitting element LD, a driving element DT that supplies a current to the light-emitting element LD, a plurality of switch elements T1 and T2 that switch a current path connected to the driving element DT, and a capacitor Cst. The driving element DT and the switch elements T1 and T2 may be implemented as p-channel transistors, but are not limited thereto.

The light-emitting element LD may include an anode electrode, a cathode electrode, and an emission layer. The cathode electrode of the light-emitting element LD may be connected to a first power line PL1 to which a pixel driving voltage EVDD is applied. The anode electrode of the light-emitting element LD may be connected to the driving element DT. The light-emitting element LD may be a light-emitting element such as an OLED, mini-LED, or micro-LED, but is not limited thereto. In the case of a mini-LED or micro-LED, the light-emitting element LD may have a vertical structure in which electrodes are arranged on the upper and lower parts of a semiconductor chip in which the light-emitting element LD is integrated, but is not limited thereto. The semiconductor chip in which the light-emitting element LD is integrated may be implemented in a lateral structure or a flip chip structure.

The driving element DT may be turned on by a voltage of a first node n1 to drive the light-emitting element LD. The driving element DT includes a gate electrode connected to the first node n1, a first electrode connected to a second node n2, and a second electrode connected to a second power line PL2 to which a pixel base voltage is applied.

A first switch element T1 supplies a data voltage Vdata to a gate electrode of the driving element DT in response to a scan signal SCAN (N). The first switch element T1 includes a gate electrode to which the scan signal SCAN (N) is applied, a first electrode connected to a data line DL to which the data voltage is applied, and a second electrode connected to the first node n1.

A second switch element T2 applies a reference voltage Vref to the second node n2 in response to a sensing signal SENSE (N). The second switch element T2 includes a gate electrode to which the sensing signal SENSE (N) is applied, a first electrode connected to the second node n2, and a second electrode connected to a reference voltage line RL to which the reference voltage Vref is applied. In addition, the second switch element T2 may be implemented as a dual transistor including two transistors connected in series, but is not limited thereto.

The capacitor Cst is connected between the first node n1 and the second node n2. The capacitor Cst includes a first electrode connected to the first node n1 and a second electrode connected to the second node n2.

The pixel circuit described herein is merely an example and is not necessarily limited thereto.

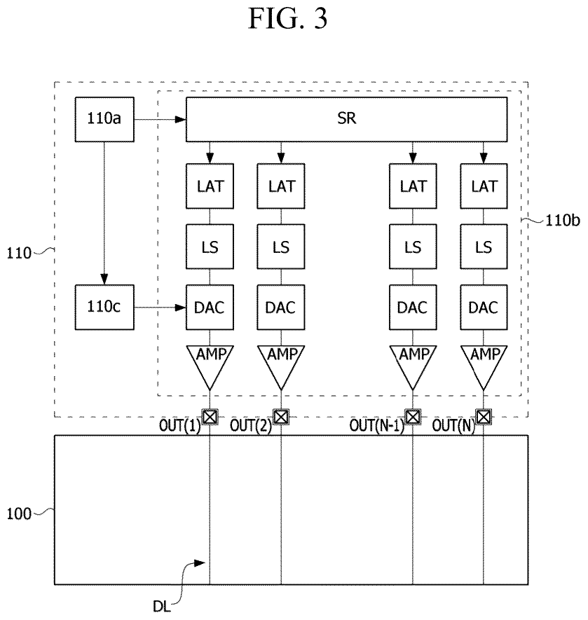

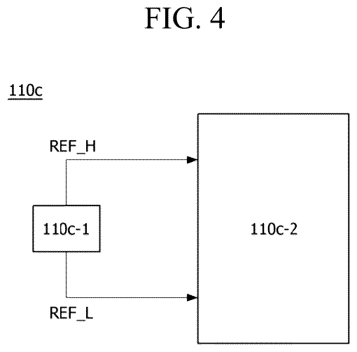

FIG. 3 is a diagram showing a configuration of a data driver according to an embodiment of the present disclosure, and FIG. 4 is a diagram showing a configuration of a gamma voltage generation circuit shown in FIG. 3.

Referring to FIG. 3, a data driver according to an embodiment of the present disclosure may include a control circuit 110a, an output circuit 110b, and a gamma voltage generation circuit 110c.

The control circuit 110a may receive pixel data and a data timing control signal from a timing controller, transmit the pixel data to the output circuit 110b based on the received data timing control signal, and control such that a first image data voltage corresponding to the pixel data, and a second image data voltage obtained by inverting the phase of the first image data voltage with respect to a reference voltage are output to corresponding data lines DL through output channels OUT(1), OUT(2), . . . , OUT(N−1), OUT (N).

The control circuit 110a may control such that the first image data voltage is output during a first period within one frame period and the second image data voltage is output during a second period.

The control circuit 110a may adjust a high-potential gamma voltage and a low-potential gamma voltage to control a data voltage range in the first and second periods within one frame period.

The voltage output circuit 110b may include a shift register SR, a latch LAT, a digital-to-analog converter DAC, and an amplifier AMP. The voltage output circuit 110b may further include a level shifter LS.

The shift register SR may shift a clock input from the timing controller to generate a sampling clock, and may sequentially output the generated sampling clock to the latches LAT.

The latches LAT may sample and store pixel data of the input image according to the timing of the sequentially input sampling clock, and may simultaneously output the stored pixel data.

The level shifters LS may convert the voltage level of the stored pixel data. The level shifters LS may convert the voltage level of the pixel data into a voltage level that may drive the DA converters DAC.

The DA converters DAC may convert the pixel data output from the latches LAT or the pixel data whose voltage level has been converted by the level shifters LS into an analog form.

The amplifier AMP may amplify the voltage level of the pixel data in analog form, and may output the pixel data with the amplified voltage level to the corresponding data lines through the output channel OUT(1), OUT(2), . . . , OUT(N−1), OUT (N) connected to the output terminals.

The gamma voltage generation circuit 110c may generate gamma voltages and provide them to the digital-to-analog converter DAC. As shown in FIG. 4, the gamma voltage generation circuit 110c may include a voltage adjustment circuit 110c-1 and a voltage generation circuit 110c-2.

The voltage adjustment circuit 110c-1 may adjust a high-potential gamma voltage REF_H and a low-potential gamma voltage REF_L during the first and second periods, respectively, within one frame period under control of the control circuit 110a. The voltage adjustment circuit 110c-1 may supply the adjusted high-potential gamma voltage REF_H and low-potential gamma voltage REF_L to the voltage generation circuit 110c-2.

The voltage generation circuit 110c-2 may generate gamma voltages for each gray-level based on the adjusted high-potential gamma voltage REF_H and low-potential gamma voltage REF_L, and supply them to the voltage output circuit 110b.

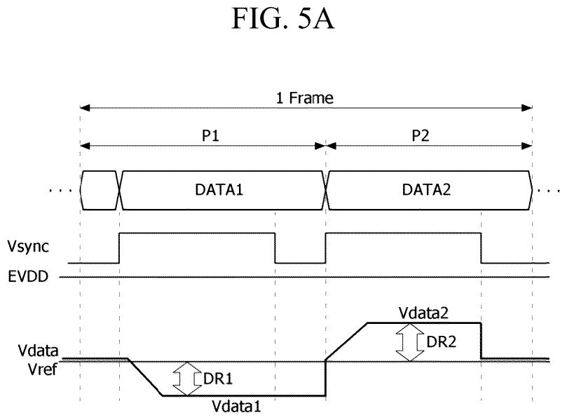

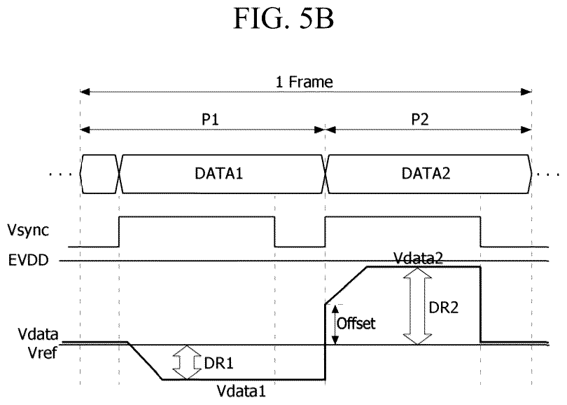

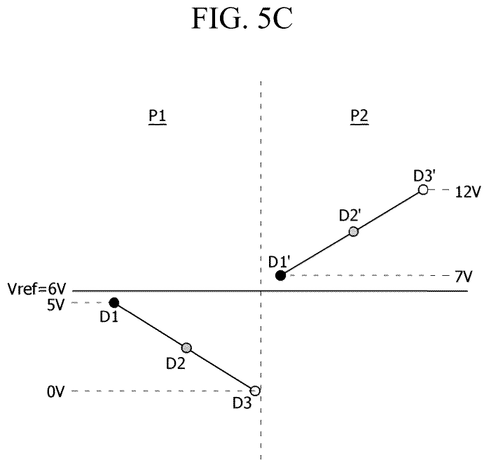

FIGS. 5A to 5C are diagrams for explaining a data voltage application principle according to a first embodiment.

Referring to FIGS. 2 and 5A, the data driver according to a first embodiment of the present disclosure may apply a first image data voltage Vdata1 during a first period P1 in one frame period, and apply a second image data voltage Vdata2, which is obtained by inverting the phase of the first image data voltage Vdata1 with respect to a reference voltage Vref, during a second period P2.

As shown in FIG. 2, when the driving element is implemented as a p-channel transistor, whether light emission occurs may be determined by a gate-to-source voltage Vgs of the driving element. That is, when the first data voltage Vdata1 applied to a gate electrode of the driving element is lower than the reference voltage Vref applied to a source electrode of the driving element, the condition Vgs <0 is satisfied, and light emission occurs; and when the second data voltage Vdata2 applied to the gate electrode of the driving element is higher than the reference voltage Vref applied to the source electrode of the driving element, the condition Vgs>0 is satisfied, and light emission does not occur. Accordingly, when the data voltage is lower than the reference voltage Vref, the light-emitting element emits light, and when the data voltage is higher than the reference voltage Vref, the light-emitting element does not emit light.

The first image data voltage Vdata1 may be set to a negative direction, and the second image data voltage Vdata2 may be set to a positive direction. That is, digital data corresponding to the first image data voltage Vdata1 may be set to a negative direction, and digital data corresponding to the second image data voltage Vdata2 may be set to a positive direction. Here, the positive direction may represent a voltage region higher than the reference voltage, and the negative direction may represent a voltage region lower than the reference voltage. For example, the first image data voltage Vdata1 may be an image data voltage of a black gray level, and the second image data voltage Vdata2 may be an image data voltage of a white gray level.

In this case, although an example is described in which the first image data voltage Vdata1 is set to a negative direction and the second image data voltage Vdata2 is set to a positive direction in a pixel circuit in which the driving element is implemented as a p-channel transistor, it is not necessarily limited thereto. For example, in a pixel circuit in which the driving element is implemented as an n-channel transistor, the first image data voltage Vdata1 may be set to a positive direction and the second image data voltage Vdata2 may be set to a negative direction.

The first image data voltage and the second image data voltage may be voltages that are symmetrical with respect to a reference voltage Vref.

The data driver may output the first and second image data voltages based on gamma voltages for each gray-level that are generated in advance. In this case, the gamma voltages for each gray-level may be generated based on a high-potential gamma voltage and a low-potential gamma voltage, and the high-potential gamma voltage and the low-potential gamma voltage may be differently set in a first period in which the first image data voltage is applied and in a second period in which the second image data voltage is applied. That is, in the first period in which the first image data voltage is applied, the voltages may be set to a first high-potential gamma voltage and a first low-potential gamma voltage, and in the second period in which the second image data voltage is applied, the voltages may be set to a second high-potential gamma voltage and a second low-potential gamma voltage.

For example, when the reference voltage Vref is 6 V, the first high-potential gamma voltage may be 5 V, the first low-potential gamma voltage may be 0 V, the second high-potential gamma voltage may be 12 V, and the second low-potential gamma voltage may be 7 V.

In this case, the first high-potential gamma voltage and the first low-potential gamma voltage may be set to voltage values less than or equal to the reference voltage Vref, and the second high-potential gamma voltage and the second low-potential gamma voltage may be set to voltage values greater than or equal to the reference voltage Vref.

The data voltage range DR1 output in the first period P1 and the data voltage range DR2 output in the second period P2 may be identical to each other with respect to the reference voltage Vref.

Referring to FIGS. 2 and 5B, the data driver according to the first embodiment of the present disclosure may apply the first image data voltage Vdata1 during a first period P1 in one frame period, and apply the second image data voltage Vdata2, which is obtained by inverting, the phase of the first image data voltage Vdata1 with respect to the reference voltage Vref, at a voltage higher than the reference voltage Vref by a predetermined offset, during a second period P2.

For example, when the reference voltage Vref is 6 V, the first high-potential gamma voltage may be 6 V, the first low-potential gamma voltage may be 0 V, the second high-potential gamma voltage may be 18 V, and the second low-potential gamma voltage may be 6 V.

The data voltage range DR1 output in a first period P1 and the data voltage range DR2 output in a second period P2 may be different from each other with respect to the reference voltage Vref. For example, the data voltage range DR2 in the second period P2 may be formed to be larger than the data voltage range DR1 in the first period P1 by a predetermined offset.

Referring to FIG. 5C, the phases of first image data voltages D1, D2, and D3 in a negative direction, which are output in the first period P1 with respect to the reference voltage Vref, may be inverted into second image data voltages D1′, D2′, and D3′ in a positive direction in the second period P2.

Specifically, in the first period P1, when the first image data of a black gray level is 1023 and a first image data voltage D1 is 5 V, and the first image data of a white gray level is 0 and a first image data voltage D3 is 0 V, if the phase is inverted with respect to a reference voltage Vref of 6 V, then in the second period P2, the second image data of a white gray level becomes 0 and a second image data voltage D1′ becomes 7 V, and the second image data of a black gray level becomes 1023 and a second image data voltage D3′ becomes 12 V.

In the first embodiment, the first image data voltages D1, D2, and D3 may vary in a range of 0 V to 5 V, and the second image data voltages D1′, D2′, and D3′ may vary in a range of 7 V to 12 V.

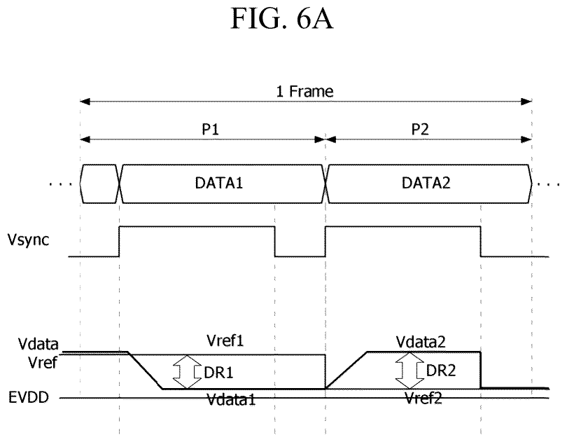

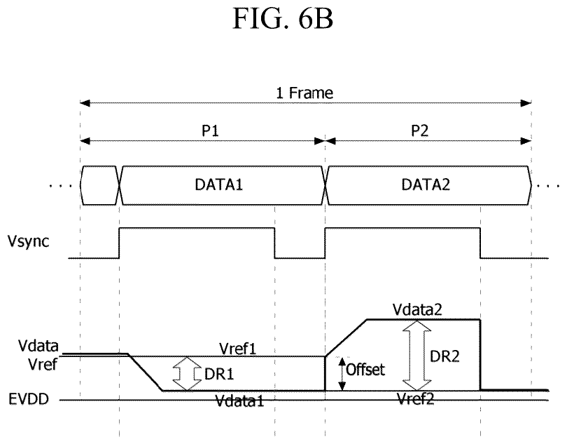

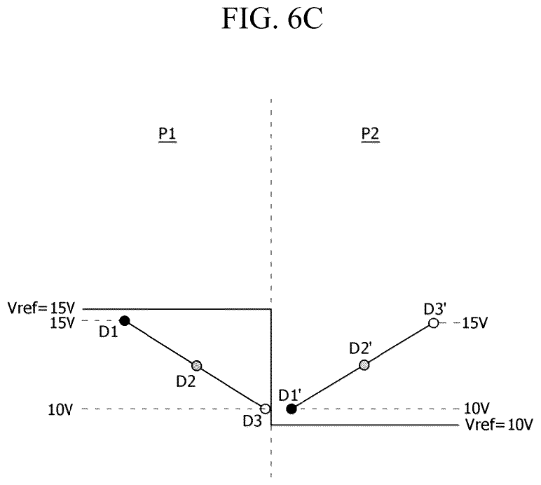

FIGS. 6A to 6C are diagrams for explaining a data voltage application principle according to a second embodiment.

Referring to FIGS. 2 and 6A, the data driver according to a second embodiment of the present disclosure may apply a first image data voltage Vdata1 during a first period P1 in one frame period and apply a second image data voltage Vdata2, which is obtained by inverting, the phase of the first image data voltage Vdata1 with respect to a first reference voltage Vref1, at a second reference voltage Vref2, during a second period P2.

In this case, the reference voltage Vref may have different voltage values in the first period P1 and the second period P2. For example, a first reference voltage Vref1 may be applied in the first period P1, and a second reference voltage Vref2, which is set to be lower than the first reference voltage Vref1 by a predetermined voltage value, may be applied in the second period P2.

The high-potential gamma voltage and the low-potential gamma voltage may be set to the same values in the first period P1 in which the first image data voltage Vdata1 is applied and in the second period P2 in which the second image data voltage Vdata2 is applied.

For example, when the high-potential gamma voltage is 15 V and the low-potential gamma voltage is 10 V, a first reference voltage Vref1 in a first period may be set to 15 V, and a second reference voltage Vref2 in a second period may be set to 10 V.

A data voltage range DR1 output in the first period P1 based on the first reference voltage Vref1 and a data voltage range DR2 output in the second period P2 based on the second reference voltage Vref2 may be the same.

Referring to FIGS. 2 and 6B, the data driver according to a second embodiment of the present disclosure may apply a first image data voltage Vdata1 during a first period P1 in one frame period and apply a second image data voltage Vdata2, which is obtained by inverting, the phase of the first image data voltage Vdata1 with respect to a first reference voltage Vref1, at a voltage higher than the second reference voltage Vref2 by a predetermined offset, during a second period P2.

In this case, the reference voltage Vref may have different voltage values in the first period P1 and the second period P2.

For example, in the first period P1 in which the first reference voltage Vref1 is 15 V, a first high-potential gamma voltage may be 15 V and a first low-potential gamma voltage may be 10 V, and in the second period P2 in which the second reference voltage Vref2 is 10 V, a second high-potential gamma voltage may be 20 V and a second low-potential gamma voltage may be 10 V.

A data voltage range DR1 output in the first period P1 based on the first reference voltage Vref1 and a data voltage range DR2 output in the second period P2 based on the second reference voltage Vref2 may be different from each other. That is, the data voltage range DR2 in the second period P2 may be larger than the data voltage range DR1 in the first period P1 by a predetermined offset.

Referring to FIG. 6C, first image data voltages D1, D2, and D3 in a negative direction, which are output in the first period P1 with respect to the reference voltage Vref, may be phase-inverted into second image data voltages D1′, D2′, and D3′ in a positive direction in the second period P2.

Specifically, in the first period P1, when the reference voltage Vref is 15 V, the first image data of a black gray level is 1023 and the first image data voltage D1 is 15 V, the first image data of a white gray level is 0 and the first image data voltage D3 is 10 V, if the reference voltage Vref is changed from 15 V to 10 V and the phase is inverted with respect to the changed reference voltage of 10 V, then in the second period P2, the second image data of a white gray level becomes 0 and the second image data voltage D1 becomes 10 V, and the second image data of a black gray level becomes 1023 and the second image data voltage D3 becomes 15 V.

In the second embodiment, the first image data voltages D1, D2, and D3 may vary in a range of 10 V to 15 V, and the second image data voltages D1′, D2′, and D3′ may vary in a range of 10 V to 15 V.

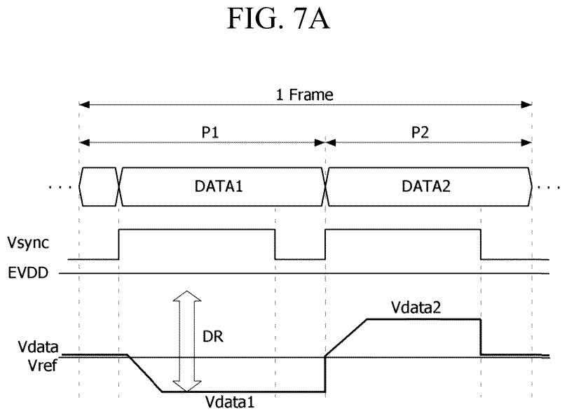

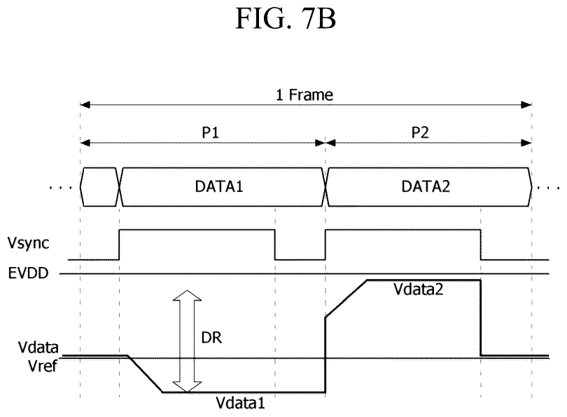

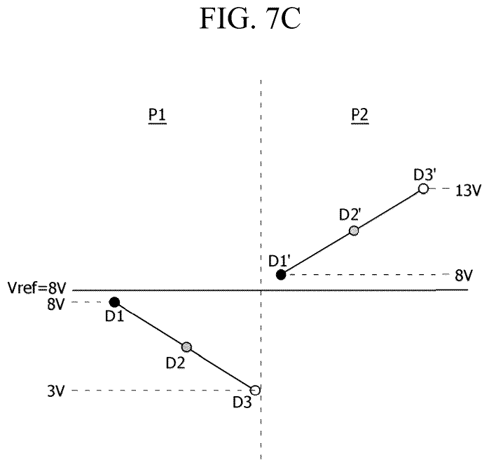

FIGS. 7A to 7C are diagrams for explaining a data voltage application principle according to a third embodiment.

Referring to FIGS. 2 and 7A, the data driver according to a third embodiment of the present disclosure may apply a first image data voltage Vdata1 during a first period P1 in one frame period and may apply a second image data voltage Vdata2, which is obtained by inverting the phase of the first image data voltage Vdata1 with respect to a reference voltage Vref, during a second period P2.

The high-potential gamma voltage and the low-potential gamma voltage may be set to the same values in the first period P1 in which the first image data voltage Vdata1 is applied and in the second period P2 in which the second image data voltage Vdata2 is applied.

The high-potential gamma voltage is higher than the reference voltage Vref, and the low-potential gamma voltage is lower than the reference voltage Vref. For example, when the reference voltage Vref is 8 V, the high-potential gamma voltage may be 13 V and the low-potential gamma voltage may be 8 V.

The data voltage range DR1 output in the first period and the data voltage range DR2 output in the second period may be identical to each other with respect to the reference voltage Vref.

Referring to FIGS. 2 and 7B, the data driver according to the third embodiment of the present disclosure may apply the first image data voltage Vdata1 during the first period P1 in one frame period, and apply the second image data voltage Vdata2, which is obtained by inverting the phase of the first image data voltage Vdata1 with respect to the reference voltage Vref but at a voltage higher than the reference voltage Vref by a predetermined offset, during a second period P2.

The high-potential gamma voltage and the low-potential gamma voltage may be set to the same values in the first period P1 in which the first image data voltage Vdata1 is applied and in the second period P2 in which the second image data voltage Vdata2 is applied.

For example, when the reference voltage Vref is 8 V, the high-potential gamma voltage may be 13 V and the low-potential gamma voltage may be 8 V.

The data voltage range DR1 output in the first period and the data voltage range DR2 output in the second period may be identical to each other with respect to the reference voltage Vref.

The data voltage range in the third embodiment may be a range that includes all the data voltages output in the first period and the second period, unlike the data voltage ranges in the first and second embodiments.

Referring to FIG. 7C, first image data voltages D1, D2, and D3 in a negative direction, which are output in the first period P1 with respect to the reference voltage Vref, may be phase-inverted into second image data voltages D1′, D2′, and D3′ in a positive direction in the second period P2.

Specifically, in the first period P1, when the first image data of a black gray level is 1023 and a first image data voltage D1 is 8 V, and the first image data of a white gray level is 0 and a first image data voltage D3 is 3 V, if the phase is inverted with respect to a reference voltage Vref of 8 V, then in the second period P2, the second image data of a white gray level becomes 0 and a second image data voltage D1′ becomes 8 V, and the second image data of a black gray level becomes 1023 and a second image data voltage D3′ becomes 13 V.

In the third embodiment, the first image data voltages D1, D2, and D3 may vary in a range of 3 V to 13 V, and the second image data voltages D1′, D2′, and D3′ may vary in a range of 3 V to 13 V.

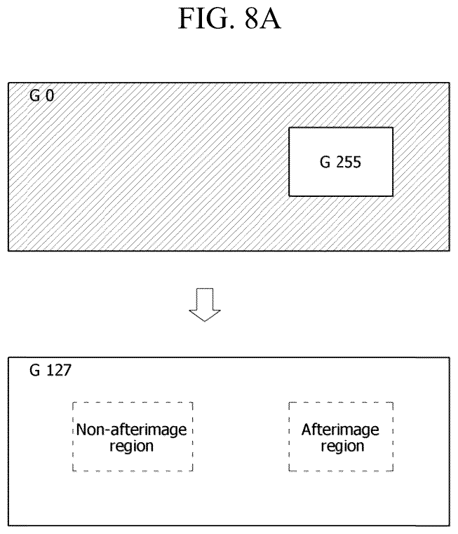

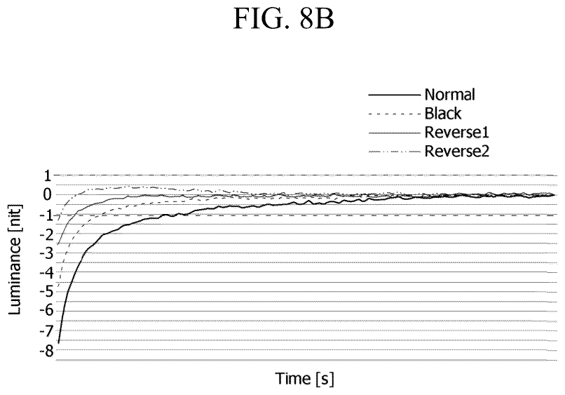

FIGS. 8A to 8B are diagrams showing simulation results according to the embodiment.

Referring to FIG. 8A, when converting a screen in which a black gray level data pattern and a white gray level data pattern are repeated into a grayscale pattern, the afterimage restoration phenomenon is evaluated.

When the driving method according to the embodiment is used, it was founded as a result of the evaluation of the afterimage restoration phenomenon that no afterimage from the previous screen is visible in the grayscale pattern.

Referring to FIG. 8B, when comparative examples including a normal driving method (Normal) and a driving method (Black) in which image data and black data are alternately applied, and embodiments including a driving method (Reverse1) in which a first image data voltage and a second image data voltage, the second image data voltage being obtained by inverting the phase of the first image data voltage with respect to a reference voltage, are applied, and a driving method (Reverse2) in which a second image data voltage obtained by inverting the phase of a first image data voltage at a voltage higher than the reference voltage by an offset is applied, are applied, a difference in luminance deviation is shown.

When the driving method according to the embodiment is applied, it can be seen that the luminance deviation is improved.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. All of the U.S. patents, U.S. patent application publications, Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A data driver comprising:
an output circuit configured to alternately output a first image data voltage corresponding to first image data, and a second image data voltage corresponding to second image data obtained by inverting a phase of the first image data voltage with respect to a voltage, during one frame period; and
a control circuit configured to supply the first image data and the second image data.

2. The data driver according to claim 1, further comprising:
a gamma voltage generation circuit configured to generate gamma voltages for each gray-level based on a high-potential gamma voltage and a low-potential gamma voltage and to supply the generated gamma voltages for each gray-level to the output circuit,
wherein the output circuit is configured to convert the first image data and the second image data into the first image data voltage and the second image data voltage based on the gamma voltage for each gray-level.

3. The data driver according to claim 2, wherein the one frame period includes a first period and a second period, and
wherein the output circuit is configured to:
output the first image data voltage during the first period, and
output the second image data voltage obtained by inverting a phase of the first image data voltage with respect to a reference voltage during the second period.

4. The data driver according to claim 3, wherein the output circuit is configured to output the second image data voltage obtained by inverting a phase of the first image data voltage at a voltage higher than the reference voltage by an offset.

5. The data driver according to claim 3, wherein the control circuit is configured to:
set the high-potential gamma voltage and the low-potential gamma voltage as a first high-potential gamma voltage and a first low-potential gamma voltage during the first period, and
set the high-potential gamma voltage and the low-potential gamma voltage as a second high-potential gamma voltage and a second low-potential gamma voltage, which are different from the first high-potential gamma voltage and the first low-potential gamma voltage, during the second period.

6. The data driver according to claim 5, wherein the first high-potential gamma voltage and the first low-potential gamma voltage are set to be lower than the reference voltage, and
the second high-potential gamma voltage and the second low-potential gamma voltage are set to be higher than the reference voltage.

7. The data driver according to claim 3, wherein the reference voltage is applied as a first reference voltage during the first period, and is applied as a second reference voltage different from the first reference voltage during the second period.

8. The data driver according to claim 3, wherein the control circuit is configured to set the high-potential gamma voltage and the low-potential gamma voltage to be same during the first period and the second period, and
wherein the high-potential gamma voltage is set to be higher than the reference voltage, and
the low-potential gamma voltage is set to be lower than the reference voltage.

9. A display device comprising:
a pixel array including a plurality of data lines, a plurality of gate lines, and a plurality of pixel circuits;
a data driver configured to output a first image data voltage and a second image data voltage to the plurality of data lines;
a gate driver configured to output gate signals to the plurality of gate lines; and
a timing controller configured to control the data driver and the gate driver,
wherein the data driver includes:
an output circuit configured to output a first image data voltage corresponding to first image data, and a second image data voltage corresponding to second image data obtained by inverting a phase of the first image data voltage with respect to a voltage during one frame period; and
a control circuit configured to supply the first image data and the second image data.

10. The display device according to claim 9, wherein the data driver further includes:
a gamma voltage generation circuit configured to generate gamma voltages for each gray-level based on a high-potential gamma voltage and a low-potential gamma voltage, and to supply the generated gamma voltages for each gray-level to the output circuit, and
wherein the output circuit is configured to convert the first image data and the second image data into the first image data voltage and the second image data voltage based on the gamma voltages for each gray-level.

11. The display device according to claim 10, wherein the one frame period includes a first period and a second period, and
wherein the output circuit is configured to:
output the first image data voltage during the first period, and
output the second image data voltage obtained by inverting a phase of the first image data voltage with respect to a reference voltage during the second period.

12. The display device according to claim 11, wherein the output circuit is configured to output the second image data voltage obtained by inverting a phase of the first image data voltage at a voltage higher than the reference voltage by an offset.

13. The display device according to claim 11, wherein the control circuit is configured to:
set the high-potential gamma voltage and the low-potential gamma voltage as a first high-potential gamma voltage and a first low-potential gamma voltage during the first period, and
set them as a second high-potential gamma voltage and a second low-potential gamma voltage, which are different from the first high-potential gamma voltage and the first low-potential gamma voltage, during the second period.

14. The display device according to claim 13, wherein the first high-potential gamma voltage and the first low-potential gamma voltage are set to be lower than the reference voltage, and
the second high-potential gamma voltage and the second low-potential gamma voltage are set to be higher than the reference voltage.

15. The display device according to claim 11, wherein the reference voltage is applied as a first reference voltage during the first period, and is applied as a second reference voltage different from the first reference voltage during the second period.

16. The display device according to claim 11, wherein the control circuit is configured to set the high-potential gamma voltage and the low-potential gamma voltage to be same during the first period and the second period, and
wherein the high-potential gamma voltage is set to be higher than the reference voltage, and
the low-potential gamma voltage is set to be lower than the reference voltage.
